(19) United States
(12) Patent Application Publication
(10) Pub. No.: US 2008/0018006 A1
(43) Pub. Date: Jan. 24, 2008

(54) Method of injection molding lens of transparent or semitransparent plastic material for producing car lights and similar

(75) Inventors: Maurizio Bazzo, Oderzo (IT); Peter Dal Bo, Vittorio Veneto (IT)

Correspondence Address: DAVIDSON BERQUIST JACKSON & GOWDEY LLP, 4300 WILSON BLVD., 7TH FLOOR, ARLINGTON, VA, 22203, US

(73) Assignee: INGLASS S.p.A., San Polo di Piave (IT)

(21) Appl. No.: 11/826,443

(22) Filed: Jul. 16, 2007

(30) Foreign Application Priority Data
Jul. 17, 2006 (IT) TV2006A 000126

(51) Int. Cl. B29D 11/00

(52) U.S. Cl. 264/1.7

(57) ABSTRACT

A method of injection molding lens bodies of transparent or semitransparent plastic material for producing car lights and similar; the lens body being defined by a convex shell made of transparent or semitransparent plastic material, and which has a concave face eventually facing the light source of the light, and a convex face eventually forming part of the outer surface of the light, and is divided into at least a first and a second monochromatic portion; the molding method forming, in succession, a first half-shell of plastic material substantially reproducing the shape of the whole shell, and, directly on the concave surface of the first half-shell, a second half-shell of plastic material only reproducing the shape of the second monochromatic portion of the shell; in both cases, the plastic material being injected into the mold through one or more injection points located at the concave face of the shell, inside the perimeter of the second monochromatic portion, which is bounded by an at least partly corrugated-profile outer surface.

The present invention relates to a method of injection molding lens bodies of transparent or semitransparent plastic material for producing car lights and similar products.

### BACKGROUND OF THE INVENTION

As is known, the lens body of a car tail-light is normally defined by a convex shell made of transparent or semitransparent material, having two monochromatic portions of different colours, and which is injection molded in two steps comprising the formation, in rapid succession, of two complementary half-shells of transparent or semitransparent plastic material, each of which is the same shape as a corresponding monochromatic portion of the convex shell, and is made of one transparent or semitransparent material.

At present, each plastic half-shell is produced by feeding the liquid plastic material into a mold—negatively reproducing the shape of the part being produced—through one or more injection points located on the inner surface portion of the mold directly facing the convex or “visible” face of the plastic shell.

In other words, the plastic material of the lens body is injected at one or more injection points appropriately distributed on the surface of the convex or “visible” face of the lens body.

Unfortunately, lens bodies injection molded as described above often have minor surface flaws at the plastic injection points, and which, being located on the “visible” face of the lens body, are clearly visible, even with the naked eye, when working with colourless plastic material, with all the drawbacks this entails. In fact, in most cases, lens bodies in which the surface flaws on the “visible” face are visible with the naked eye are treated as rejects.

### SUMMARY OF THE INVENTION

It is an object of the present invention to provide a method of injection molding lens bodies of transparent or semitransparent plastic material, designed to conceal the surface defects at the injection points.

According to the present invention, there is provided a method of injection molding lens bodies of transparent or semitransparent plastic material for producing car lights and similar products.

### BRIEF DESCRIPTION OF THE DRAWINGS

A non-limiting embodiment of the present invention will be described by way of example with reference to the accompanying drawings, in which:

FIG. 1 shows a view in perspective of a lens body of transparent or semitransparent plastic material, produced in accordance with the teachings of the present invention;

FIGS. 2 and 3 show two steps in the method of injection molding the lens body in FIG. 1.

### DETAILED DESCRIPTION OF THE INVENTION

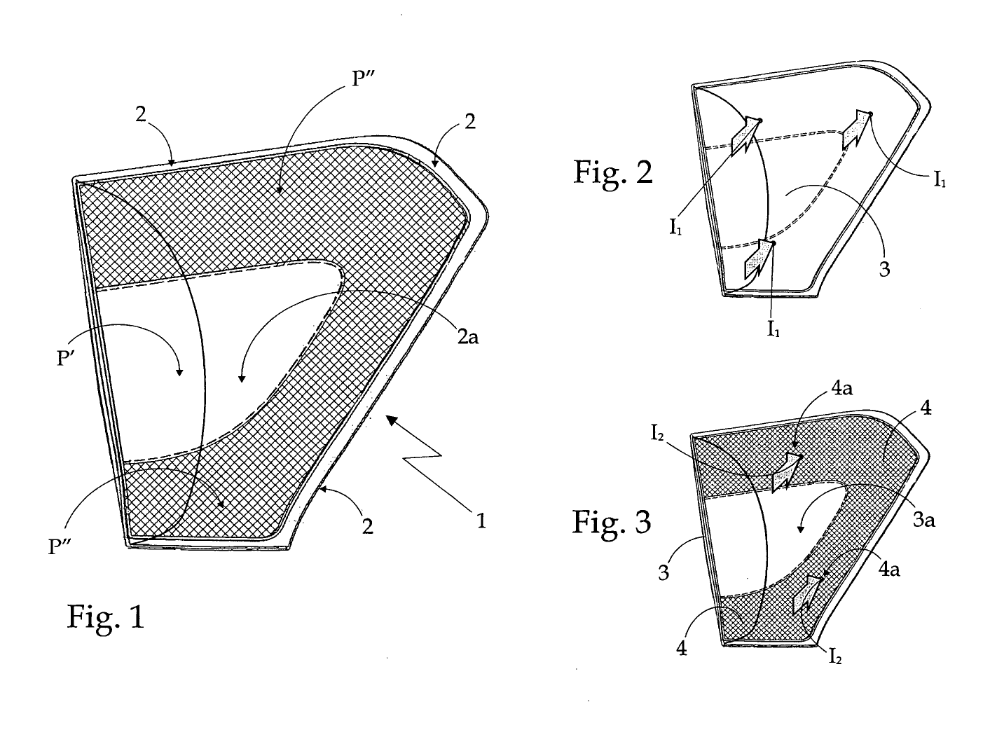

Number 1 in FIG. 1 indicates as a whole a lens body for producing car lights and similar products.

Lens body 1 is defined by a convex shell 2 made of transparent or semitransparent plastic material and comprising a concave or inner face 2a eventually facing the light source of the light, and a convex or “visible” face eventually forming part of the outer surface of the light. Shell 2 is divided into at least two monochromatic, contiguous, complementary portions P′ and P″, which are preferably, though not necessarily, of different colours and/or different degrees of transparency.

In the example shown, monochromatic portion P′ is substantially colourless, and monochromatic portion P″ is red and less transparent than monochromatic portion P′.

With reference to FIG. 1, in addition, at least part of the surface of concave face 2a of shell 2 inside the perimeter of monochromatic portion P″ of shell 2 has an evenly corrugated profile.

More specifically, in the example shown, the whole of the surface portion of concave face 2a inside the perimeter of monochromatic portion P″ of shell 2 has an evenly corrugated profile.

More specifically, in the example shown, the surface portion of concave face 2a of shell 2 inside the perimeter of monochromatic portion P″ has a number of adjacent, equally spaced cavities, to form an embossed-like profile for deflecting the light evenly in the surrounding space.

With reference to FIGS. 2 and 3, shell 2 of transparent or semitransparent plastic material is produced using an injection molding method, which comprises, in succession:

a first plastic material injection step, in which a first half-shell 3 of plastic material, substantially reproducing the shape of the whole shell 2, is formed inside the mold negatively reproducing the shape of shell 2; and

a second plastic material injection step, in which, inside the mold negatively reproducing the shape of shell 2, and directly on the concave surface 3a of half-shell 3 corresponding to concave face 2a of shell 2, a second half-shell 4 of plastic material is formed, which only reproduces the shape of monochromatic portion P″ of shell 2, and is bounded at the top by an outer surface 4a having at least one portion with an evenly corrugated profile.

More specifically, in the example shown, the first half-shell 3 is preferably, though not necessarily, made of transparent or semitransparent colourless plastic material, and the second half-shell 4 is preferably, though not necessarily, made of transparent or semitransparent coloured plastic material.

Unlike known solutions, at the first injection step, plastic half-shell 3 is produced by feeding the plastic material into the mold through one or more injection points I₁ arranged on the inner surface of the mold so that each directly faces what will eventually become the surface portion of concave face 2a of shell 2 corresponding to monochromatic portion P″.

Similarly, at the second injection step, plastic half-shell 4 is produced by feeding the plastic material into the mold, directly onto concave surface 3a of half-shell 3, through one or more injection points I₂ arranged on the inner surface of the mold so that each directly faces what will eventually become the surface portion of concave face 2a of shell 2 enclosed inside the perimeter of monochromatic portion P″. In addition, each injection point I₂ is located on the inner surface of the mold to directly face what will eventually become the surface portion of concave face 2a of shell 2 located inside monochromatic portion P″ and having an evenly corrugated profile.

In other words, in both cases, the plastic material is injected into the mold—negatively reproducing the shape of shell 2, i.e. lens body 1 of transparent or semitransparent material—through one or more injection points I₁, I₂ located at concave face 2a of shell 2, inside the perimeter of monochromatic portion P″.

In addition, injection points I₂ in the second injection step are arranged on the inner surface of the mold so that each is located at the evenly-corrugated-profile portion of outer surface 4a defining the top of half-shell 4.

More specifically, in the example shown, injection points I₂ are arranged on the inner surface of the mold so that each is located at the bottom of a respective cavity of the evenly-corrugated-profile portion of outer surface 4a of half-shell 4.

The method described above of injection molding lens bodies of plastic material has major advantages: forming half-shell 4 on concave surface 3a of half-shell 3 and over injection points I₁ conceals the surface flaws on half-shell 3 at injection points I₁ completely, while locating injection points I₂ directly at the bottom of some of the cavities in evenly-corrugated surface 4a of half-shell 4 completely conceals the surface flaws of second half-shell 4 at injection points I₂.

Clearly, changes may be made to the method of injection molding lens bodies 1 of transparent or semitransparent plastic material for producing car lights, as described and illustrated herein, without, however, departing from the scope of the present invention.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A method of injection molding lens bodies of transparent or semitransparent plastic material comprising a convex shell made of transparent or semitransparent plastic material and having a concave face eventually facing a light source, and a convex face eventually forming part of the outer surface of the lens, the shell being divided into at least first and second monochromatic portions contiguous to each other, the method comprising the steps of:
injecting a first plastic material in which a first half-shell of plastic material, substantially reproducing the shape of the whole shell, is formed inside a mold negatively reproducing the shape of said shell; and
injecting a second plastic material inside the mold and directly on the concave surface of the first half-shell thereby forming a second half-shell of plastic material which only reproduces the shape of the second monochromatic portion of the shell;
during the first injection the plastic material is fed into the mold through at least one first injection point located on an inner surface of the mold so as to directly face what will eventually become the concave face of the shell inside a perimeter of the second monochromatic portion; and
during the second injection the plastic material is fed into the mold through at least one second injection point located on the inner surface of the mold so as to directly face what will eventually become the concave face of the shell inside the perimeter of the second monochromatic portion.

2. The method of injection molding lens bodies as in claim 1, wherein the second half-shell is bounded at a top portion by an outer surface having at least one portion with a corrugated profile; and during the second injection the plastic material is fed into the mold through at least one second injection point located on the inner surface of the mold so as to directly face what will eventually become the corrugated-profile portion.

3. The method of injection molding lens bodies as in claim 2, wherein said second half-shell top portion further includes a number of cavities equally spaced on at least a portion of the outer surface; and during the second injection the plastic material is fed into the mold through at least one second injection point located on the inner surface of said mold and located at the bottom of a respective cavity of the corrugated-profile portion.

4. The method of injection molding lens bodies as in claim 1, wherein during the first injection the plastic material fed into the mold is a colourless plastic material.

5. A method of injection molding lens bodies of as in claim 1, wherein during the second injection the plastic material fed into the mold is a coloured plastic material.
